(19) United States
(12) Patent Application Publication
(10) Pub. No.: US 2003/0128844 A1
(43) Pub. Date: Jul. 10, 2003

(54) DRYBEDOC THE EMBOL Language private communication system

(76) Inventor: Paul Douglas Byrd, Tok, AK (US)

Correspondence Address: Paul Douglas Byrd, Mile 123.5 Tok Cutoff, P.O Box 442, Tok, AK, 99780, US

(21) Appl. No.: 09/822,475

(22) Filed: Mar. 29, 2001

(51) Int. Cl. H04K 1/00

(52) U.S. Cl. 380/59

(57) ABSTRACT

It is said that all things in our universe are linked and even a small disturbance at one point will reverberate and affect all other constituent elements. This statement may be refuted in the real world, but is becoming valid in the virtual world where most activities can be watched by others linked to the Web. One solution used to stop internet intruders from reading messages, credit cards and files is encryption. Encryption is the altering of original information using various techniques and transmitting that data for decryption. A problem with file encryption is that a hacker who is able to access an encrypted file will get enough indication the file is encrypted to trigger his curiosity to discover the real information. If a file is intercepted by a skilled hacker all the effort to encrypt the file is useless. * Data needs to be transmitted in such a way that it prevents others from reading it directly. DRYBEDOC THE [symbol] EMBOL Language transfers message information by encrypting original information as language data to the font style. * Example: page 28.

Note: It is necessary for clarity to present the example as shown.

### CROSS-REFERENCE TO RELATED APPLICATIONS

Cryptography techniques

There is no other cryptography technique comparable to DRYBEDOC THE [symbol] EMBOL Language Private Communication System.

1. DRYBEDOC THE [symbol] EMBOL Language (D [symbol] TEL)

A. A new language.

B. Geometrically generated.

C. Cryptography technique.

1. Encrypts font or style with information.

a. Style is font typeface.

b. Font when used is text.

c. Text has alphabet value.

d. D [symbol] TEL text has font and alphabet values.

2. Private Communication System

A. A new font.

1. Geometrically generated from the copyright design THE [symbol] EMBOL.

a. Font characters are generated by exactly reproducing lines from THE [symbol] EMBOL.

b. May carry more than face value information.

B. The font is the private communication system.

1. A font must be installed to be produced.

a. THE [symbol] EMBOL font used in production of this document can not be reproduced, as text, by any other computer or system anywhere in the world.

C. Exclusively available from drybedoc.

3. Other cryptography techniques

A. Quantum physics

B. Algorithms

C. Number calculation

D. Codes

E. Pictures

F. Gimmicks

G. Trickery

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The design was conceived as a code game for my 9 year old daughter. The design lines initally drawn were named after the English alphabet letters and became known as THE [symbol] EMBOL. The game was to disquise an alphabet so that a secret message could be made and sent to a decoder. As the lines were drawn different characters took shape. Some line combinations produced shapes that duplicate or closely resemble English alphabet letters. DRYBEDOC became the language of geometric shapes constructed by reproducing the lines of one unique design. The creation of such a large number of characters led to a limited publishing of the book ‘DRYBEDOC’ which was commercially printed in 1988. The book contains a solve and win $100.00 message in which the DRYBEDOC characters were produced by hand. A marketing attempt was made by mailing the DRYBEDOC book to game makers, electronic device manufacturers, and some local businesses. Responses of “Wow and Neat idea” produced no buyers. Over the next several years ‘DRYBEDOC’ was only occasionally discussed with family and friends, but did not die. An effort in1997-98 led to the design line combinations producing all of the DRYBEDOC [symbol] Alphabet large case letters, small case letters, numbers, and punctuation characters. A system emerged allowing characters (EMBOLS) to be constructed two ways; expressing design line names that create characters and expressing alphabet names that create design lines that create characters. Graphing the quantity of different lines used in character construction produced an alphabet that no longer was plain ABC. The name of A became qferd. The name of B became KNEf. The name of C became cLd. etc., so that all English alphabet characters have a DRYBEDOC equivalent character with a critically case sensitive name. The language, time consuming to print, because it can not be cursively written or seemingly possible to humanly speak, provides a way to make words say more than is written. Characters that change names simply by changing the design line names make it possible that every alphabet character may have a different character name. This unique system allows previously written information to be encrypted to transmit DRYBEDOC data. On July 17, 1998 THE [symbol] EMBOL of DRYBEDOC THE [symbol] EMBELIC Language was issued United States of America copyright #VAu 440-556. A computer and a font building program provided the means to create electronically the unique DRYBEDOC font. Two more books, displaying the font, were self published and distributed during 1999. The books, DRYBEDOC [symbol] The EMBELIC Language and DRYBEDOC I I I, were submitted to several prominent technology firms and three government affiliated encryption agencies and numerous internet inquires were made to colleges and universities and government agencies seeking any interest. At that time the tech industry was booming and no one was looking for another font, no matter how unique. It is now 2001 and private electronic data whether personal, industrial, financial, or medical has been made public knowledge. The FBI recently released information that states cyber theft of proprietary information and credit card loss in billions of dollars. It is apparent that the many and various systems designed to protect private information have been unsuccessful.

March 21, 2001 is the 414th day (posted on the internet) that a win $10,000.00 US message, ‘Find the Font’, has been offered to anyone who could post the URL of any site, other than the DRYBEDOC site, that displays the DRYBEDOC [symbol] Font.

Also, today is the 329th day that a ‘Solve the $10,000.00 Message’ (Illustration #1, page 9) has been posted on the same site;

www.delphi.com/~drybedoc

[image]

### BRIEF SUMMARY OF THE INVENTION

DRYBEDOC THE [symbol] EMBOL Language Private Communication System; utilizing the physics of geometry, accomplishes private communication thru unique creation, transmission, and storage of information.

Facts

1. A new language.

2. Can be written.

3. Can be spoken.

4. Especially suited to digital communication.

5. Stops unauthorized copy of language font.

6. Naturally exclusive intranet.

7. Transfers data without exposing the original information.

a. DRYBEDOC is not alphabet.

1. It is a font (style).

a. Compatible with all alphabets.

2. A style (typeface) of alphabet.

a. DRYBEDOC data is encrypted to alphabet as style.

8. Encrypts previously published information with personal information and transmits as language data.

9. Guarantees integrity of each communication by having one central connection point.

10. Only customized to the client DRYBEDOC [symbol] Font will be released.

a. To ensure integrity all DRYBEDOC [symbol] TEL systems will be created on site.

1. Estimated creation time approximately 1 to 2 weeks.

11. Unauthorized reproductions of DRYBEDOC THE [symbol] EMBOL Language Private Communication System are excluded from becoming part of the Original D [symbol] TEL Private Communication System.

a. Only customized to client systems have contact and communication procedure.

12. This document, in its entirety, can not be identically reproduced by typed text, by any other computer or system anywhere in the world.

13. FUN!

### BRIEF DESCRIPTION OF THE SEVERAL VIEWS OF THE DRAWING

Not Applicable

### DETAILED DESCRIPTION OF THE INVENTION

DRYBEDOC THE [symbol] EMBOL Language Private Communication System

1. DRYBEDOC THE [symbol] EMBOL Language (D [symbol] TEL)

A. Is not English.

B. Is a new geometric language.

C. Encrypts font (style) as information.

1. May carry more than face value information.

2. THE [symbol] EMBOL

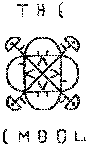

See: THE [symbol] EMBOL page 31

A. 26 independent geometric line designs uniquely fit together.

1. Assigned equivalent names of English alphabet characters A thru Z.

2. Any change of design names results in name changes of some or all EMBOLS (fonts).

B. Produces an unlimited quantity of fonts (EMBOLS).

1. D [symbol] TEL fonts are produced using Macromedia Fontgrapher 4.0 Font Making Program.

a.** Each character is THE [symbol] EMBOL with specified lines removed.

Example: **

[image]

D [symbol] TEL characters are created using this construction technique.

1. All fonts are created using font making programs.

a. Follow font making program manufacturer instructions.

3. EMBOLS (fonts)

A. Character shapes

1. Exactly reproduced line by line from THE [symbol] EMBOL.

a. Appear as English alphabet letters, numbers, and punctuation and graphic characters.

2. Critically case sensitive.

a. Use of ALL of an independent line design in construction receives a LARGE CASE LETTER in its name.

b. Use of PART of an independent line design in construction receives a small case letter in its name.

3. Can be encrypted with multiple D [symbol] TEL values.

B. Names

1. Assigned such that each character can equal any alphabet character.

2. Changed by assigning THE [symbol] EMBOL lines different names allowing characters to change names without changing size, shape, color, or appearance.

a. Number of name changes is determined by quantity of installed DRYBEDOC [symbol] Alphabets.

1. Computer memory size determines quantity of DRYBEDOC [symbol] Alphabets that can be installed.

C. Alphabets

1. Unlimited quantity can be generated by THE [symbol] EMBOL.

2. One DRYBEDOC [symbol] Alphabet consists of:

a. 26 LARGE CASE LETTERS: See LARGE CASE LETTERS—BIG Klat (talK) page 32

b. 26 small case letters: See small case letters—little Klat (talK) page 33

c. 10 numbers: See numbers page 34

d. 26 punctuation : See Punctuation pages 35, 36, 37

e. 39 graphic characters: See graphics page 38

See other DRYBEDOC [symbol] Fonts pages 45, 46, 47

4. Encryption technique

Every keystroke, in addition to face value information is language data.

A. Encrypted font contain one or more values.

1. Translation

a. Identical with English language values.

2. Alphabet

a. Alphabet characters have measurable (to the pixel) geometric value, and may have assigned numeric, and assigned alphabet values.

3. Geometric

a. Lines of THE [symbol] EMBOL have measurable (to the pixel) alphabet, number, and geometric values.

4. Numeric

a. Number characters have measurable (to the pixel) geometric value, and may have assigned alphabet, and assigned numeric values.

5. Graphic

a. Graphic characters have measurable (to the pixel) geometric value, and may have assigned alphabet, and assigned numeric values.

6. Artistic

a. Has art values.

7. None

a. Has no information values.

5. Private Communication System

A. Installs as a font.

1. Font must be installed to be produced.

B. The font is the private communication system.

C. There is only one D [symbol] TEL supply source.

6. Definition of terms and conditions

A. DRYBEDOC: My last name, BYRD, and CODE; spelled backward individually and aligned as one word; Pronounced DRY BE DOC.

B. [symbol] =

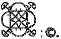

THE [symbol] EMBOL size increase is for clarity.

C. THE [symbol] EMBOL: The copyright design from which all EMBOLS are created.

D. EMBOL: Any character (font) created line by line from THE [symbol] EMBOL.

E. Font: An assortment of type all of one size and style; definition by Webster's Dictionary 7th New Collegiate.

F. Klat: talK spelled backward.

G. All other words are of standard English definition.

H. Assigned Information values are encrypted and transmitted as part of message.

I. DRYBEDOC is compatible with all languages.

J. This document can not be exactly reproduced until DRYBEDOC THE [symbol] EMBOL Language is installed.

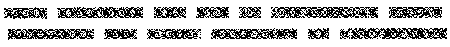

Practical application of invention:

DRYBEDOC THE [symbol] EMBOL Language Private Communication System for Government, Business and Individuals.

1. D [symbol] TEL

A. Provides keyboard operator and able client with a private communication system.

B. Excludes all unauthorized access of language information.

1. Only equipment with client D [symbol] TEL installed are capable of communication in client D [symbol] TEL.

2. Only the encrypting and decrypting client have message D [symbol] TEL.

3. Provides self limiting copyright.

a. Can not be electronically produced, viewed or printed unless installed.

b. THE [symbol] EMBOL, copyright 1988, was issued United States of America copyright #VAu 440-556, July 17, 1998.

1. Therefore, communication using DRYBEDOC THE [symbol] EMBOL Language is protected by United States of America copyright laws, although unnecessarily.

C. Requires minimum installation of 13 D [symbol] TEL Alphabets.

1. Largest D [symbol] TEL system: 169 [symbol] Alphabets.

2. Each installed alphabet increases security.

3. There are no duplicate alphabets.

D. Compatible with software and hardware that allows font installation.

Method of operation of invention:

Step 1.

Obtain CD from drybedoc that contains ready to install D [symbol] TEL Private Communication System.

A. Each CD contains one system.

1. All systems are customized to client.

Step 2.

Insert CD into computer CD player.

Step 3.

Open CD icon that appears on screen.

Step 4.

Install DRYBEDOC [symbol] Alphabets from CD by following equipment manufacturer font installation procedure.

A. Uninstall

1. Follow manufacturer procedure.

Step 5.

Open a word processing program.

A. Begin encryption of original information.

1. Previously published information can be encrypted to carry D [symbol] TEL data that decrypted is different information. See Security page 39

2. Any letter of a word may be encrypted by selecting a different DRYBEDOC [symbol] Alphabet.

a. Any alphabet, punctuation, number, or graphic character can be encrypted as any character.

b. Every keyboard character contains a complete DRYBEDOC [symbol] Alphabet.

3. Use customized font sequence or track and log sequence used and transmit with message.

B. Customized D [symbol] TEL perform all or part of encryption and decryption procedures.

Step 6.

Storage of original information.

A. To insure privacy store original information as encrypted data.

1. Security can be increased after transmission by re-encrypting data to encryptor private.

Step 7.

Transmission of encrypted data.

A. Send as e-mail or as an attachment to e-mail.

1. Computers that do not have D [symbol] TEL installed will view data in the selected or default font.

B. Can be posted on the internet as a picture file.

a. A font can not be electronically reproduced as text without being installed.

C. Can be computer printed as a private document.

1. Documents printed using D [symbol] TEL can be security marked and verified for authenticity.

D. Can be produced by hand.

E. Can be spoken. See Speakability page 48

1. Tell specifics of existing publication used for transmission of D [symbol] TEL encrypted data.

This document, in its entirety, can not be reproduced, as typed text, by any other computer or equipment any where in the world.

[image]

[image]

[image]

[image]

[image]

[image]

[image]

[image]

[image]

[image]

[image]

[image]

[image]

[image]

[image]

[image]

[image]

[image]

[image]

1. I claim all rights to all means or abilities of all computers or computer programs or operating systems of any and all communication devices, whether currently existing, in research and development stages and any that will be built, to create from or install or use any or all stated or unstated phenomena, properties and processes unique to DRYBEDOC THE [symbol] EMBOL Language, THE [symbol] EMBOL, and DRYBEDOC THE [symbol] EMBOL Language Private Communication System.

2. I claim all rights to all means and abilities of any and all digital audio devices, whether currently existing, in research and development stages and any that will be built, to create from or install or use any or all stated or unstated phenomena, properties and processes unique to DRYBEDOC THE [symbol] EMBOL Language, THE [symbol] EMBOL, and DRYBEDOC THE [symbol] EMBOL Language Private Communication System.

3. I claim all rights to all means and abilities of any and all digital video devices, whether currently existing, in research and development stages and any that will be built, to create from or install or use any or all stated or unstated phenomena, properties and processes unique to DRYBEDOC THE [symbol] EMBOL Language, THE [symbol] EMBOL, and DRYBEDOC THE [symbol] EMBOL Language Private Communication System.
